(19) United States
(12) Patent Application Publication
(10) Pub. No.: US 2026/0360952 A1
(43) Pub. Date: Nov. 12, 2026

(54) SERVICEABLE FUSE CARDS FOR TRACTION BATTERY ARRAYS

(71) Applicant: FORD GLOBAL TECHNOLOGIES, LLC, Dearborn, MI (US)

(72) Inventors: Daniel Paul Roberts, Livonia, MI (US); Alexey Konstantinov, Southgate, MI (US); Daryl Arnell Marlow, Dearborn, MI (US); Francisco Fernandez-Galindo, Canton, MI (US)

(21) Appl. No.: 19/201,373

(22) Filed: May 7, 2025

(51) Int. Cl. H01M 50/583; B60L 50/64; H01M 10/42; H01M 10/48; H01M 50/211; H01M 50/249; H01M 50/519

(52) U.S. Cl. CPC H01M 50/583; B60L 50/64; H01M 10/425; H01M 10/482; H01M 50/211; H01M 50/249; H01M 50/519; H01M 2010/4271; H01M 2010/4278; H01M 2200/103; H01M 2220/20

(57) ABSTRACT

Serviceable battery arrays are provided for a traction battery pack. An exemplary battery array may include a plurality of battery cells that are electrically connected by a battery interconnect assembly. The battery interconnect assembly may include a fuse card that is removably connectable to a fuse card receptacle. In the event of a fuse opening event (e.g., a high current situation that causes a break in the circuit), the fuse card may be removed from the battery array and replaced with another fuse card to extend the operable life of the battery array.

### TECHNICAL FIELD

This disclosure relates generally to electrified vehicle traction battery packs, and more particularly to serviceable fuse cards for battery arrays of a traction battery pack.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, a battery array including a fuse card receptacle and a fuse card removably connectable to the fuse card receptacle.

In a further non-limiting embodiment of the foregoing traction battery pack, the battery array includes a plurality of battery cells packaged inside an array housing.

In a further non-limiting embodiment of either of the foregoing traction battery packs, the fuse card receptacle is mounted inside the array housing of the battery array.

In a further non-limiting embodiment of any of the foregoing traction battery packs, the fuse card receptacle is mounted between the plurality of battery cells and a top cover of the array housing.

In a further non-limiting embodiment of any of the foregoing traction battery packs, the fuse card includes a circuit board, a plurality of sense lead fuses mounted to the circuit board, and a plurality of contacts.

In a further non-limiting embodiment of any of the foregoing traction battery packs, the circuit board includes a groove sized to receive a tongue feature of an array housing of the battery array.

In a further non-limiting embodiment of any of the foregoing traction battery packs, the circuit board includes a face plate that encloses a slot of an array housing of the battery array when the fuse card is secured to the fuse card receptacle.

In a further non-limiting embodiment of any of the foregoing traction battery packs, the plurality of contacts are provided at an edge of the circuit board.

In a further non-limiting embodiment of any of the foregoing traction battery packs, the plurality of contacts are provided within a connector of the fuse card.

In a further non-limiting embodiment of any of the foregoing traction battery packs, an input wiring operably connects a sense lead of the battery array to the fuse card receptacle.

In a further non-limiting embodiment of any of the foregoing traction battery packs, the sense lead is connected to a bus bar of the battery array. The bus bar is connected to a battery cell terminal of the battery array.

In a further non-limiting embodiment of any of the foregoing traction battery packs, an output wiring operably connects the fuse card receptacle to a sensing unit of the battery array.

In a further non-limiting embodiment of any of the foregoing traction battery packs, a second fuse card is connectable to the fuse card receptacle when the fuse card is disengaged from the fuse card receptacle.

A traction battery pack according to another exemplary aspect of the present disclosure includes, among other things, a battery array including a plurality of battery cells, and a battery interconnect assembly configured to electrically connect the plurality of battery cells. The battery interconnect assembly includes a fuse card that is removably connectable to a fuse card receptacle.

In a further non-limiting embodiment of the foregoing traction battery pack, the battery interconnect assembly includes an input wiring that operably connects the plurality of battery cells to the fuse card receptacle.

In a further non-limiting embodiment of the foregoing traction battery pack, the input wiring includes a sense lead trace of a sense lead that connects to a bus bar that is connected to a terminal of a battery cell of the plurality of battery cells.

In a further non-limiting embodiment of either of the foregoing traction battery packs, the battery interconnect assembly includes an output wiring that operably connects the fuse card receptacle to a sensing unit of the battery array.

In a further non-limiting embodiment of any of the foregoing traction battery packs, the fuse card includes a circuit board, a plurality of sense lead fuses mounted to the circuit board, and a plurality of contacts.

In a further non-limiting embodiment of any of the foregoing traction battery packs, the fuse card receptacle is mounted within an array housing of the battery array, and the fuse card is insertable through a slot formed through a wall of the array housing.

A method according to another exemplary aspect of the present disclosure includes, among other things, removing a first fuse card from a battery array of a traction battery pack in response to a fuse opening event, and replacing the first fuse card with a second fuse card.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack for an electrified vehicle.

FIG. 3 schematically illustrates an exemplary battery interconnect assembly for a battery array of a traction battery pack.

FIG. 4 illustrates an exemplary sense lead fuse card system of a battery interconnect system.

FIG. 5 illustrates another exemplary sense lead fuse card system of a battery interconnect system.

FIG. 6 illustrates an exemplary fuse card of a battery interconnect system.

FIG. 7 illustrates another exemplary fuse card of a battery interconnect system.

FIG. 8 illustrates yet another exemplary sense lead fuse card system of a battery interconnect system.

FIG. 9 schematically illustrates an exemplary battery servicing method.

### DETAILED DESCRIPTION

This disclosure details serviceable battery arrays for a traction battery pack. An exemplary battery array may include a plurality of battery cells that are electrically connected by a battery interconnect assembly. The battery interconnect assembly may include a fuse card that is removably connectable to a fuse card receptacle. In the event of a fuse opening event (e.g., a high current situation that causes a break in the circuit), the fuse card may be removed from the battery array and replaced with another fuse card to extend the operable life of the battery array. These and other features are discussed in greater detail in the following paragraphs of this detailed description.

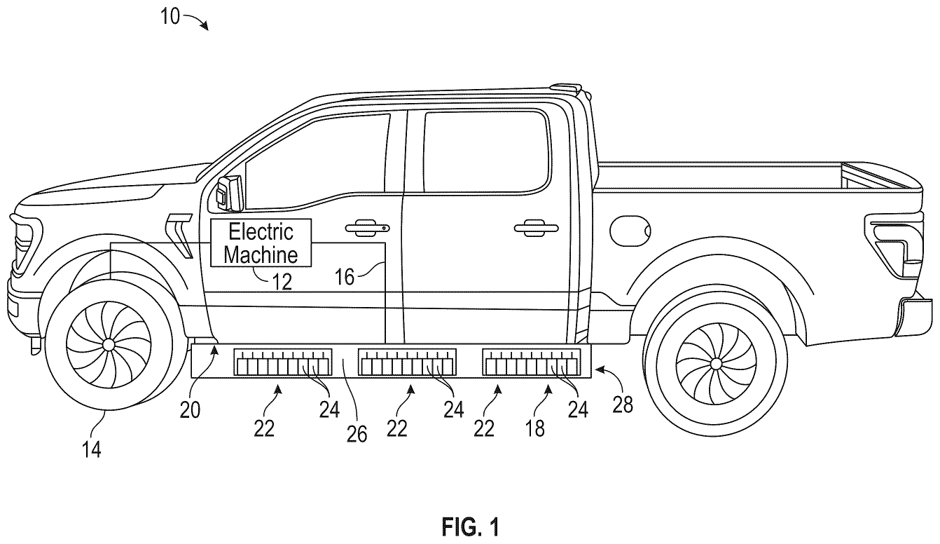

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

As schematically shown, the traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

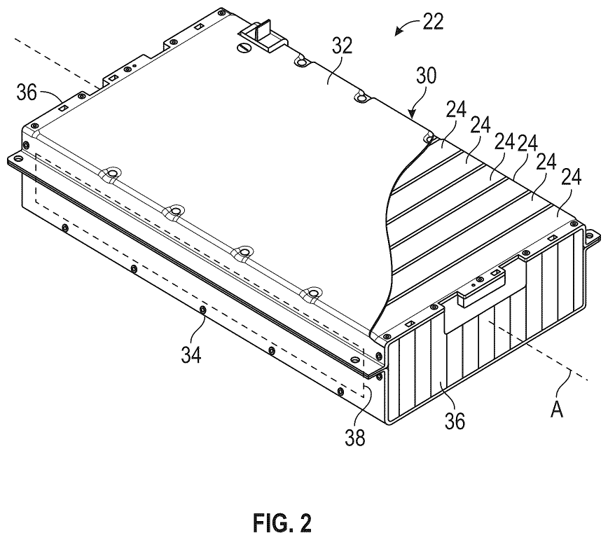

FIG. 2 illustrates features associated with an exemplary battery array 22 for use within the traction battery pack 18 of the electrified vehicle 10 of FIG. 1. One or more battery arrays having a design similar to the battery array 22 of FIG. 2 could be packaged within the traction battery pack 18.

The battery array 22 may include a plurality of battery cells 24 that are arranged together along a cell stack axis A. The battery cells 24 may be housed within an array housing 30. Notably, the array housing 30 is a separate housing from the enclosure assembly 28 of the traction battery pack 18 of FIG. 1.

The array housing 30 may include a top cover 32, a bottom cover 34, and a pair of end plates 36. The top cover 32 may be positioned vertically above the bottom cover 34. Various terms such as “above,” “below,” “top,” and “bottom” are used relative to the arrangement of the components of the traction battery pack 18 in the various drawings and should not otherwise be deemed limiting. These terms are described with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The top cover 32 may be secured (e.g., bolted, welded, adhered, etc.) to the bottom cover 34. Moreover, the top cover 32 and/or the bottom cover 34 may be secured (e.g., bolted, welded, adhered, etc.) to the end plates 36. The top cover 32, the bottom cover 34, and the end plates 36 can be arranged together to provide a sealed enclosure for housing the battery cells 24 of the battery array 22. However, other array housing configurations are contemplated within the scope of this disclosure. Accordingly, the size, shape, and configuration of the array housing 30 could vary within the scope of this disclosure.

The battery array 22 may additionally include a battery interconnect assembly 38 for electrically connecting the battery cells 24 to one another. The battery interconnect assembly 38 may provide an integrated circuit for electrically connecting and balancing the voltage levels of the battery cells 24. For example, the battery interconnect assembly 38 may be configured to measure the voltages of each battery cell 24 and to deliver the voltage readings to a control module associated with a battery management system of the electrified vehicle 10, such as a battery electronic control module (BECM), for example, as part of a control strategy for controlling charging and discharging operations of the traction battery pack 18. The control module of the battery management system may process the voltage readings for setting the appropriate power limits of the traction battery pack 18 and for monitoring the general health of each battery cell 24.

In existing battery array designs, the battery interconnect assembly 38 includes fuses that protect the battery cells 24 of the battery array 22 against accidental short circuit events and other fault modes. These fuses are typically hard mounted (e.g., soldered, crimped, etc.) directly to the battery array 22 and therefore are not serviceable. In the event of a relatively high current event, the fuses can open to break the circuit and prevent an over-current situation. However, once the fuse opens, the battery array 22 is no longer functional and must be replaced. This disclosure is therefore directed to battery interconnect assemblies that include serviceable fuse cards that allow the battery array to be serviced and then reused after a fuse opening event by simply replacing the open fuse card with another fuse card.

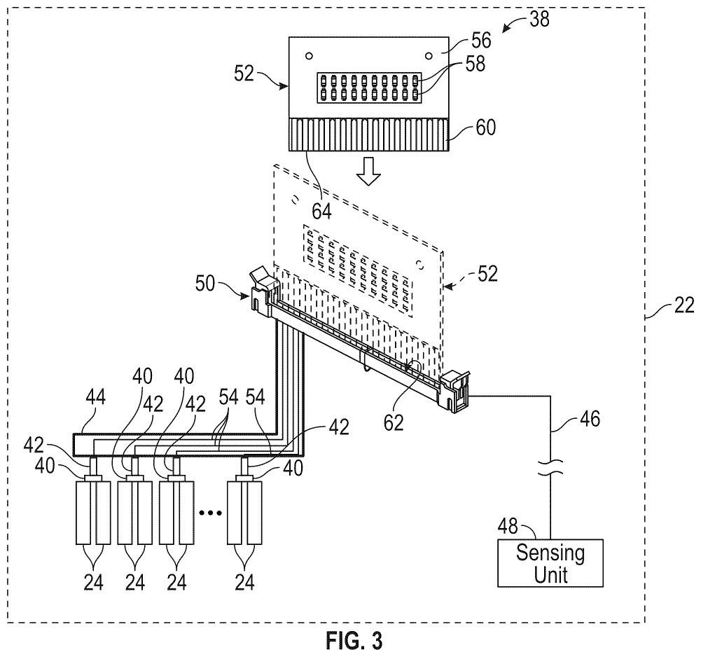

FIG. 3, with continued reference to FIG. 2, illustrates an exemplary battery interconnect assembly 38 that can be used for electrically connecting the battery cells 24 of the battery array 22 and further for monitoring and communicating data (e.g., temperature, voltage, current, state of charge, etc.) associated with the battery cells 24 as part of a battery management system of the traction battery pack 18. The battery interconnect assembly 38 may include bus bars 40, sense leads 42, input wiring 44, output wiring 46, a sensing unit 48, a fuse card receptacle 50, and a fuse card 52.

Terminals of adjacent battery cells 24 of the battery array 22 may be electrically connected together by the bus bars 40. The bus bars 40 may be metallic components. In an embodiment, the bus bars 40 are made of copper or aluminum. However, other materials or combinations of materials are contemplated within the scope of this disclosure. The bus bars 40 may be joined (e.g., welded) to the terminals of the battery cells 24 of the battery array 22 for electrically connecting the battery cells 24.

Each sense lead 42 may be joined to one of the bus bars 40 and may be configured to collect data (e.g., temperature, voltage, current, state of charge, etc.) associated with the battery cells 24. In an embodiment, the sense leads 42 may be secured to the bus bars 40 by one or more welds (e.g., laser welds).

Conductive traces 54 of the sense leads 42 may extend on or within the input wiring 44, which may operably connect the sense leads 42 to the fuse card receptacle 50. The input wiring 44 may be configured as a flexible printed circuit and therefore can include a relatively thin and flexible substrate that is made of a pliable or bendable material.

The data collected by the sense leads 42 may be fed to the fuse card receptacle 50 via the input wiring 44 and may then be fed from the fuse card receptacle 50 to the sensing unit 48 via the output wiring 46. In an embodiment, the sensing unit 48 is a battery pack sensing module that is operable to periodically communicate data to a controller (e.g., BECM) associated with the battery management system as part of the control strategy for controlling charging and discharging operations of the traction battery pack 18.

As schematically shown, the fuse card 52 may be removably connected to the fuse card receptacle 50. Together, the fuse card receptacle 50 and the fuse card 52 provide a sense lead fuse card system of the battery interconnect assembly 38. As further explained below, the fuse card 52 can be removed from the fuse card receptacle 50 and replaced with another fuse card in the event of a fuse opening event, thereby restoring the battery array 22 to a like-new condition.

The fuse card 52 may include a circuit board 56, a plurality of sense lead fuses 58 that are mounted to the circuit board 56, and a plurality of contacts 60. The circuit board 56 may be a printed circuit board, such as an FR-4 type printed circuit board, for example. The total number of sense lead fuses 58 mounted on the circuit board 56 may be equal to the total number of sense leads 42 provided within the battery interconnect assembly 38.

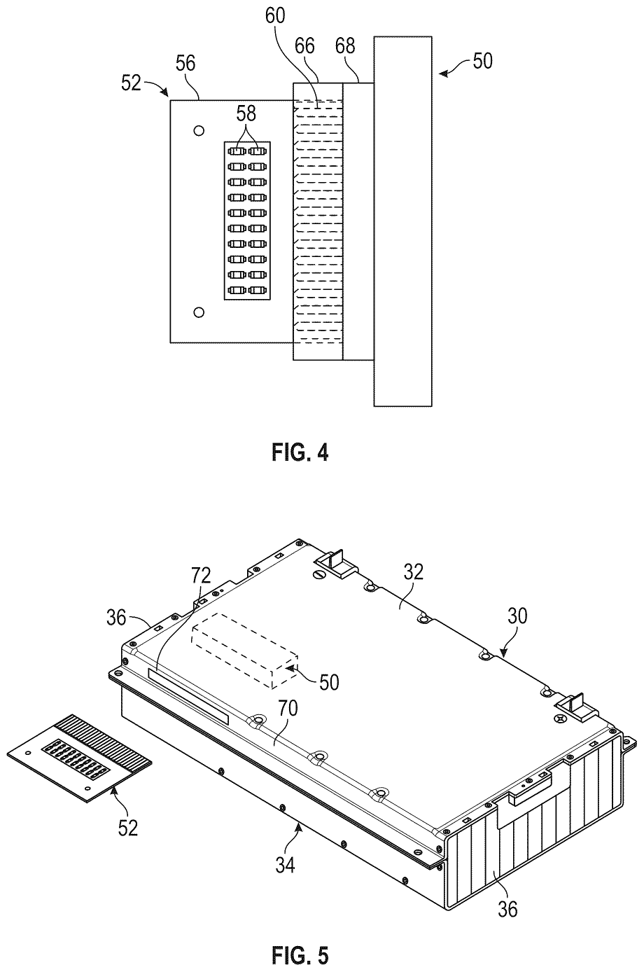

In an embodiment, the fuse card receptacle 50 include includes a receiving slot 62 for receiving the fuse card 52. The contacts 60 of the fuse card 52 may be located at an edge 64 of the circuit board 56. The contacts 60 may operably connect the fuse card 52 to the fuse card receptacle 50 when the fuse card 52 is received within the receiving slot 62 as part of a connector-to-card edge design (see FIG. 3). In another embodiment, the fuse card 52 may include a connector 66 that houses the contacts 60 and which can be connected to a header 68 of the fuse card receptacle 50 as part of a pin-type connector design (see FIG. 4).

In the event of a relatively high current event, one or more of the sense lead fuses 58 of the fuse card 52 may open to break the sense lead circuit and prevent any over-current scenario from influencing the operability of the battery cells 24. The fuse card 52 may then be removed and simply replaced with a new or different fuse card in order to restore the battery array 22 to full operability.

The fuse card receptacle 50 may be mounted anywhere within the battery array 22 where there is a sufficient amount of space to allow the fuse card 52 to be connected to and disconnected from the fuse card receptacle 50 when servicing the battery array 22. In the exemplary embodiment shown in FIG. 5, for example, the fuse card receptacle 50 is mounted in the space between the tops of the battery cells 24 and the top cover 32 of the array housing 30. A side wall 70 of top cover 32 may include a slot 72 that is sized to receive the fuse card 52 to allow the fuse card 52 to be connected to or disconnected from the fuse card receptacle 50. For example, the fuse card 52 can be slid into the slot 72 and then moved into engagement with the fuse card receptacle 50 when connecting the fuse card 52 to the fuse card receptacle 50.

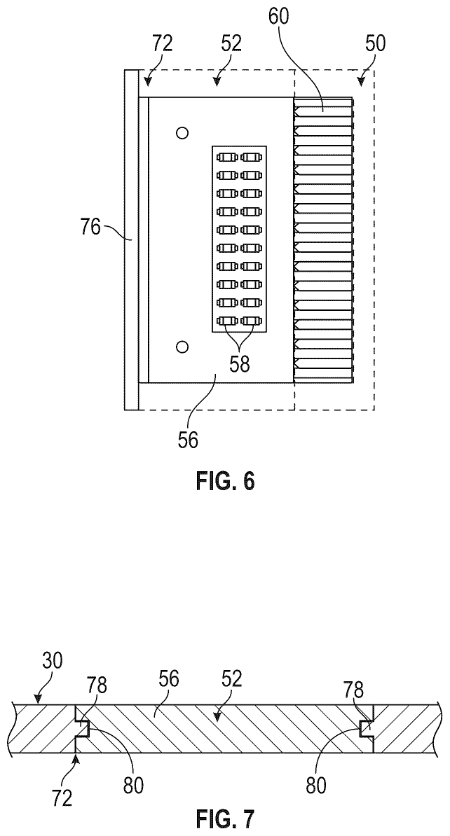

In another embodiment, shown in FIG. 6, the fuse card 52 may include a face plate 76 that is mounted to the circuit board 56. The face plate 76 may be enlarged relative to the circuit board 56 and may substantially enclose the slot 72 when the fuse card 52 is secured to the fuse card receptacle 50. The fuse card 52 may be ejected from the slot 72 by manipulating the face plate 76, such as similar to the manner in which a SIM card tray operates, for example.

In another embodiment, shown in FIG. 7, the array housing 30 may provide a pair of tongue features 78 that are configured to engage opposing edge grooves 80 formed in the circuit board 56 of the fuse card 52. The tongue features 78 may guide the sliding movement of the fuse card 52 as it is inserted into the slot 72 for engagement with the fuse card receptacle 50.

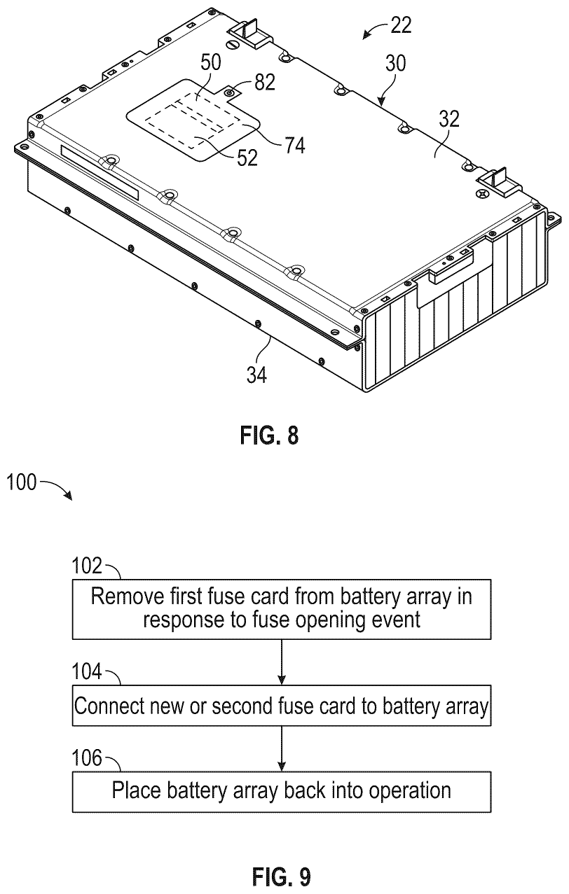

In yet another embodiment, shown in FIG. 8, the array housing 30 of the battery array 22 may include a lid 74. The lid 74 may be removably mounted to the top cover 32 or any other portion of the array housing 30 by one or more fasteners 82. The lid 74 may be selectively removed to access the fuse card receptacle 50 when the fuse card 52 needs to be removed and replaced, for example.

FIG. 9, with continued reference to FIGS. 1-8, schematically illustrates a method 100 for servicing the traction battery pack 18 of the electrified vehicle 10. The method 100 may be performed, for example, in response to an over-current event in which one or more sense lead fuses 58 of a fuse card 52 of a battery array 22 of the traction battery pack 18 open to break the electrical circuit in the path to the battery cells 24. This may be referred to as a fuse opening event.

First, at block 102, the fuse card 52 with the open sense lead fuse(s) 58 may be removed from the battery array 22. This may include disengaging the fuse card 52 from the fuse card receptacle 50.

Next, at block 104, a new or second fuse card 52 may be connected to the battery array 22. This may include connecting the new or second fuse card 52 to the fuse card receptacle 50.

Finally, at block 106, the battery array 22 with the new or second fuse card 52 may be placed back into operation. Replacing the fuse card in the above manner extends the operable life of the battery array 22.

The exemplary battery interconnect assemblies of this disclosure provide removable fuse cards that allow for simple and reliable servicing of battery arrays in response to overcurrent conditions. The removable fuse cards may be removed and replaced with new fuse cards in order to extend the operable life of the battery arrays. Among other benefits, the proposed designs can reduce battery array servicing and manufacturing complexities and reduce scrap and recycling expenses.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery array including a fuse card receptacle and a fuse card removably connectable to the fuse card receptacle.

2. The traction battery pack as recited in claim 1, wherein the battery array includes a plurality of battery cells packaged inside an array housing.

3. The traction battery pack as recited in claim 2, wherein the fuse card receptacle is mounted inside the array housing of the battery array.

4. The traction battery pack as recited in claim 3, wherein the fuse card receptacle is mounted between the plurality of battery cells and a top cover of the array housing.

5. The traction battery pack as recited in claim 1, wherein the fuse card includes a circuit board, a plurality of sense lead fuses mounted to the circuit board, and a plurality of contacts.

6. The traction battery pack as recited in claim 5, wherein the circuit board includes a groove sized to receive a tongue feature of an array housing of the battery array.

7. The traction battery pack as recited in claim 5, wherein the circuit board includes a face plate that encloses a slot of an array housing of the battery array when the fuse card is secured to the fuse card receptacle.

8. The traction battery pack as recited in claim 5, wherein the plurality of contacts are provided at an edge of the circuit board.

9. The traction battery pack as recited in claim 5, wherein the plurality of contacts are provided within a connector of the fuse card.

10. The traction battery pack as recited in claim 1, wherein an input wiring operably connects a sense lead of the battery array to the fuse card receptacle.

11. The traction battery pack as recited in claim 10, wherein the sense lead is connected to a bus bar of the battery array, and further wherein the bus bar is connected to a battery cell terminal of the battery array.

12. The traction battery pack as recited in claim 10, wherein an output wiring operably connects the fuse card receptacle to a sensing unit of the battery array.

13. The traction battery pack as recited in claim 1, comprising a second fuse card that is connectable to the fuse card receptacle when the fuse card is disengaged from the fuse card receptacle.

14. A traction battery pack, comprising:
a battery array including a plurality of battery cells; and
a battery interconnect assembly configured to electrically connect the plurality of battery cells,
wherein the battery interconnect assembly includes a fuse card that is removably connectable to a fuse card receptacle.

15. The traction battery pack as recited in claim 14, wherein the battery interconnect assembly includes an input wiring that operably connects the plurality of battery cells to the fuse card receptacle.

16. The traction battery pack as recited in claim 15, wherein the input wiring includes a sense lead trace of a sense lead that connects to a bus bar that is connected to a terminal of a battery cell of the plurality of battery cells.

17. The traction battery pack as recited in claim 14, wherein the battery interconnect assembly includes an output wiring that operably connects the fuse card receptacle to a sensing unit of the battery array.

18. The traction battery pack as recited in claim 14, wherein the fuse card includes a circuit board, a plurality of sense lead fuses mounted to the circuit board, and a plurality of contacts.

19. The traction battery pack as recited in claim 14, wherein the fuse card receptacle is mounted within an array housing of the battery array, and the fuse card is insertable through a slot formed through a wall of the array housing.

20. A method, comprising:
removing a first fuse card from a battery array of a traction battery pack in response to a fuse opening event; and
replacing the first fuse card with a second fuse card.
